(19) United States
(12) Patent Application Publication
(10) Pub. No.: US 2026/0125057 A1
(43) Pub. Date: May 7, 2026

(54) METHOD AND DEVICE FOR DRIVING ASSISTANCE

(71) Applicants: HYUNDAI MOTOR COMPANY, Seoul (KR); Kia Corporation, Seoul (KR)

(72) Inventors: Hyunsu KIM, Hwaseong-si (KR); Sae Yong JANG, Hwaseong-si (KR); Minju KIM, Hwaseong-si (KR)

(21) Appl. No.: 19/275,824

(22) Filed: Jul. 21, 2025

(30) Foreign Application Priority Data
Nov. 4, 2024 (KR) 10-2024-0154354

(51) Int. Cl. B60W 30/14; B60W 30/182; B60W 50/00; B60W 50/12; B60W 50/14

(52) U.S. Cl. CPC B60W 30/146; B60W 30/182; B60W 50/12; B60W 50/14; B60W 2050/0083; B60W 2050/146; B60W 2520/10; B60W 2540/10; B60W 2540/215; B60W 2554/4042; B60W 2555/60; B60W 2556/45

(57) ABSTRACT

A method for driving assistance using a vehicle's computing device comprises receiving data from a navigation device about entering a specified zone and its speed limit. Upon entering the zone, the method includes obtaining the vehicle's current speed and accelerator pedal position, comparing the current speed with the speed limit, and issuing commands to decelerate if the speed exceeds the limit. If the speed is at or below the limit, the method detects if the accelerator pedal is pressed and overrides vehicle acceleration if the pedal is pressed and the speed exceeds the limit.

### CROSS-REFERENCE TO RELATED APPLICATION

This application claims priority to and the benefit of Korean Patent Application No. 10-2024-0154354 filed in the Korean Intellectual Property Office on Nov. 4, 2024, the entire contents of which are incorporated herein by reference.

### TECHNICAL FIELD

The present disclosure relates to a method and a device for driving assistance, and more particularly, to a method and a device for driving assistance in a protection zone for vulnerable road users.

### BACKGROUND

A protection zone for vulnerable road users is a designated area established to enhance the safety of individual who are may be more susceptible to harm in the event of a traffic accident. Such zones may include a children protection zone, a senior protection zone, and a disabled protection zone. Specific road sections, such as those surrounding schools, senior centers, or care facilities, may have reduced speed limits or parking restrictions to safeguard children, the elderly, and persons with disabilities. Additionally, penalties for traffic violations within these zones have been strengthened, with fines often doubled compared to standard penalties.

### SUMMARY

The present disclosure is directed to a method and a device for driving assistance that are capable of assisting driving in a protection zone for vulnerable road users, thereby reducing accident occurrences and preventing regulation violation.

According to an aspect of the present disclosure a method for driving assistance, which assists vehicle driving in a protection zone for vulnerable road users, and is performed by a computing device implemented in a vehicle and including a processor and a communication interface, the method can include: receiving, by the processor, first data on whether the vehicle enters the protection zone and second data on a speed limit within the protection zone from a navigation device of the vehicle via an internal network of the vehicle; determining, by the processor, whether a value of the first data indicates that the vehicle enters the protection zone; receiving, by the processor, third data on a current speed of the vehicle and fourth data on an accelerator pedal position of the vehicle via the internal network of the vehicle if the value of the first data is determined to indicate that the vehicle enters the protection zone; comparing, by the processor, the current speed provided from the third data with the speed limit provided from the second data; transmitting, by the processor, a command to a vehicle integration controller installed in the vehicle to decelerate the current speed if the current speed exceeds the speed limit; detecting, by the processor, whether an accelerator pedal is pressed based on the accelerator pedal position provided from the fourth data if the current speed is the speed limit or less; and transmitting, by the processor, the command to the vehicle integration controller to override vehicle acceleration by accelerator pedal control when the current speed provided from the third data begins to exceed the speed limit if the accelerator pedal is pressed.

The method may further include receiving, by the processor, a value for setting a deceleration mode for the vehicle deceleration from a memory or a storage device accessible by the computing device, and the transmitting the command to the vehicle integration controller installed in the vehicle to decelerate the current speed may include, transmitting, by the processor, the command to the vehicle integration controller to decelerate the current speed to first acceleration after a first time elapses after the vehicle enters the protection zone if the value for setting the deceleration mode indicates a first deceleration mode. The transmitting the command to the vehicle integration controller installed in the vehicle to decelerate the current speed may include, transmitting, by the processor, the command to the vehicle integration controller to decelerate the current speed to second acceleration that is different from the first acceleration after the first time elapses after the vehicle enters the protection zone if the value for setting the deceleration mode indicates a second deceleration mode that is different from the first deceleration mode.

The transmitting the command to the vehicle integration controller installed in the vehicle to decelerate the current speed may include, transmitting, by the processor, the command to the vehicle integration controller to decelerate the current speed to the first acceleration or the second acceleration after a second time that is different from the first time elapses after the vehicle enters the protection zone if the value for setting the deceleration mode indicates a third deceleration mode that is different from the first deceleration mode.

The method may further include: receiving, by the processor, fifth data on a current speed of a following vehicle via the internal network of the vehicle; calculating, by the processor, deceleration acceleration of the vehicle based on the third data; calculating, by the processor, deceleration acceleration of the following vehicle based on the fifth data; comparing, by the processor, the deceleration acceleration of the vehicle with the deceleration acceleration of the following vehicle; and transmitting, by the processor, the command to the vehicle integration controller installed in the vehicle to prevent current speed control from being performed if the deceleration acceleration of the following vehicle is greater than the deceleration acceleration of the vehicle.

The method may further include: receiving, by the processor, fifth data on a current speed of a following vehicle via the internal network of the vehicle; and transmitting, by the processor, the command to the vehicle integration controller installed in the vehicle to prevent current speed control from being performed if the current speed of the following vehicle is greater than a predetermined reference speed.

The method may further include: receiving, by the processor, fifth data on a current speed of a following vehicle via the internal network of the vehicle; and transmitting, by the processor, the command to the vehicle integration controller installed in the vehicle to prevent current speed control from being performed if the current speed of the following vehicle is greater than the current speed of the vehicle.

The method may further include: displaying, by the processor, a user interface indicating a question about deactivating a function related to the driving assistance on a display device included in the vehicle; and transmitting, by the processor, the command to the vehicle integration controller installed in the vehicle to prevent current speed control from being performed if a user requests the deactivation of the function through the user interface.

The method may further include transmitting, by the processor, the current speed provided from the third data to a remote server through a communication interface if the value of the first data is determined to indicate that the vehicle enters the protection zone.

The method may further include transmitting, by the processor, the command to a black box mounted on the vehicle through the communication interface to instruct the black box to start video recording if the value of the first data is determined to indicate that the vehicle enters the protection zone.

According to another aspect of the present disclosure, a device for driving assistance, which assists vehicle driving in a protection zone for vulnerable road users by executing an instruction, loaded in at least one memory device, through at least one processor implemented in a vehicle, wherein the at least one processor configured to execute the instruction to perform operations, the operations can include receiving first data on whether the vehicle enters the protection zone and second data on a speed limit within the protection zone from a navigation device of the vehicle via an internal network of the vehicle, determining whether a value of the first data indicates that the vehicle enters the protection zone, receiving third data on a current speed of the vehicle and fourth data on an accelerator pedal position of the vehicle via the internal network of the vehicle if the value of the first data is determined to indicate that the vehicle enters the protection zone, comparing the current speed provided from the third data with the speed limit provided from the second data, transmitting a command to a vehicle integration controller installed in the vehicle to decelerate the current speed if the current speed exceeds the speed limit, detecting whether an accelerator pedal is pressed based on the accelerator pedal position provided from the fourth data if the current speed is the speed limit or less, and transmitting the command to the vehicle integration controller to override vehicle acceleration by accelerator pedal control when the current speed provided from the third data begins to exceed the speed limit if the accelerator pedal is pressed.

The operations may further include receiving, by the processor, a value for setting a deceleration mode for the vehicle deceleration from a memory or a storage device accessible by the computing device, and the transmitting the command to the vehicle integration controller installed in the vehicle to decelerate the current speed includes, transmitting, by the processor, the command to the vehicle integration controller to decelerate the current speed to first acceleration after a first time elapses after the vehicle enters the protection zone if the value for setting the deceleration mode indicates a first deceleration mode.

The transmitting the command to the vehicle integration controller installed in the vehicle to decelerate the current speed includes, transmitting, by the processor, the command to the vehicle integration controller to decelerate the current speed to second acceleration that is different from the first acceleration after the first time elapses after the vehicle enters the protection zone if the value for setting the deceleration mode indicates a second deceleration mode that is different from the first deceleration mode.

The transmitting the command to the vehicle integration controller installed in the vehicle to decelerate the current speed includes, transmitting, by the processor, the command to the vehicle integration controller to decelerate the current speed to the first acceleration or the second acceleration after a second time that is different from the first time elapses after the vehicle enters the protection zone if the value for setting the deceleration mode indicates a third deceleration mode that is different from the first deceleration mode.

The operations may further include receiving, by the processor, fifth data on a current speed of a following vehicle via the internal network of the vehicle; calculating, by the processor, deceleration acceleration of the vehicle based on the third data; calculating, by the processor, deceleration acceleration of the following vehicle based on the fifth data; comparing, by the processor, the deceleration acceleration of the vehicle with the deceleration acceleration of the following vehicle; and transmitting, by the processor, the command to the vehicle integration controller installed in the vehicle to prevent current speed control from being performed if the deceleration acceleration of the following vehicle is greater than the deceleration acceleration of the vehicle.

The operations may further include receiving, by the processor, fifth data on a current speed of a following vehicle via the internal network of the vehicle; and transmitting, by the processor, the command to the vehicle integration controller installed in the vehicle to prevent current speed control from being performed if the current speed of the following vehicle is greater than a predetermined reference speed.

The operations may further include receiving, by the processor, fifth data on a current speed of a following vehicle via the internal network of the vehicle; and transmitting, by the processor, the command to the vehicle integration controller installed in the vehicle to prevent current speed control from being performed if the current speed of the following vehicle is greater than the current speed of the vehicle.

The operations may further include displaying, by the processor, a user interface indicating a question about deactivating a function related to the driving assistance on a display device included in the vehicle; and transmitting, by the processor, the command to the vehicle integration controller installed in the vehicle to prevent current speed control from being performed if a user requests the deactivation of the function through the user interface.

The operations may further include transmitting, by the processor, the current speed provided from the third data to a remote server through a communication interface if the value of the first data is determined to indicate that the vehicle enters the protection zone.

According to another aspect of the present disclosure, a non-transitory computer-readable recording medium having an instruction to be executed by a computing device implemented in a vehicle and including a processor and a communication interface, wherein the instruction is executed by the computing device, thus causing the computing device to receive first data on whether the vehicle enters a protection zone for vulnerable road users and second data on a speed limit within the protection zone from a navigation device of the vehicle via an internal network of the vehicle, determine whether a value of the first data indicates that the vehicle enters the protection zone, receive third data on a current speed of the vehicle and fourth data on an accelerator pedal position of the vehicle via the internal network of the vehicle if the value of the first data is determined to indicate that the vehicle enters the protection zone, compare the current speed provided from the third data with the speed limit provided from the second data, transmit a command to a vehicle integration controller installed in the vehicle to decelerate the current speed if the current speed exceeds the speed limit, detect whether an accelerator pedal is pressed based on the accelerator pedal position provided from the fourth data if the current speed is the speed limit or less, and transmit the command to the vehicle integration controller to override vehicle acceleration by accelerator pedal control when the current speed provided from the third data begins to exceed the speed limit if the accelerator pedal is pressed.

### BRIEF DESCRIPTION OF THE DRAWINGS

FIG. 1 is a diagram illustrating an example of a device for driving assistance.

FIG. 2 is a diagram illustrating an example of a method for driving assistance.

FIG. 3 is a diagram illustrating an example of a method for driving assistance.

FIG. 4 is a diagram illustrating an example of a method for driving assistance.

FIG. 5 is a diagram illustrating an example of a method for driving assistance.

FIG. 6 is a diagram illustrating an example of a computing device.

### DETAILED DESCRIPTION

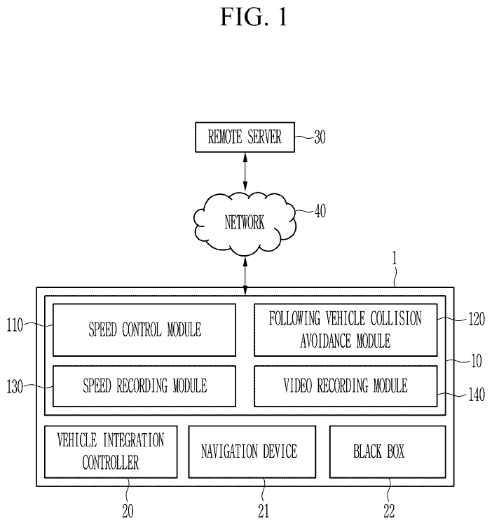

FIG. 1 is a diagram illustrating an example of a device for driving assistance.

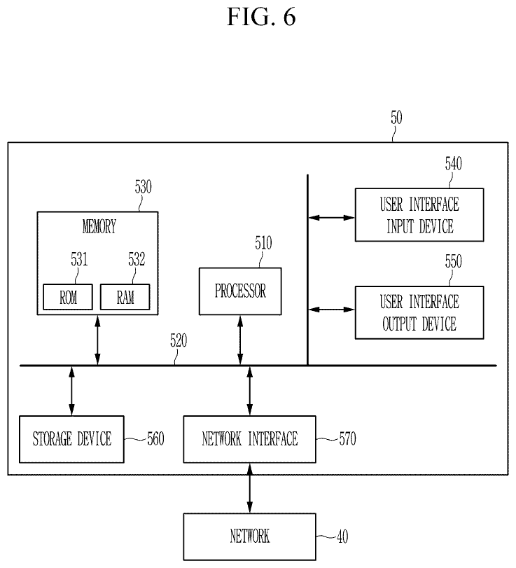

Referring to FIG. 1, a device 10 for driving assistance can execute a program code or an instruction, loaded in at least one memory device, through at least one processor. For example, the device 10 for driving assistance can be implemented as a computing device 50 as described below with reference to FIG. 6. Here, the computing device 50 can be implemented in a vehicle 1, for example, implemented as a controller mounted on the vehicle 1. In some implementations, at least one processor can correspond to a processor 510 of the computing device 50, and at least one memory device can correspond to a memory 530 of the computing device 50. The program code or the instruction, executed by at least one processor, can assist driving in a protection zone for vulnerable road users. In the specification, a term “module” may be used to logically distinguish and describe functions performed by the program code or the instruction.

The device 10 for driving assistance can be implemented in the vehicle 1. The device 10 for driving assistance can exchange data with a vehicle integration controller 20, a navigation device 21, and a black box 22 implemented together in the vehicle 1 through an internal network. In some implementations, the internal network may include a controller area network (CAN), a local interconnect network (LIN), automotive Ethernet, or the like. The vehicle integration controller 20 can be a device that comprehensively manages and controls various systems installed in the vehicle 1.

In some implementations, the device 10 for driving assistance can exchange the data with a remote server 30 through a network 40. Here, the remote server 30 can indicate a server owned or serviced by a transportation company. For example, the vehicle 1 can be a goods delivery vehicle and communicate with the remote server 30 to receive various information, including delivery routes, delivery schedules, and delivery stages. In addition, the vehicle 1 can provide the remote server 30 with various information regarding delivery states, a state of the vehicle 1, and the like. The network 40 can include a wireless network, which can be implemented, for example, as a cellular network or a wireless fidelity (WIFI) network.

The device 10 for driving assistance can include a speed control module 110, a following vehicle collision avoidance module 120, a speed recording module 130, and a video recording module 140.

The speed control module 110 can impose a speed limit and an acceleration limit when the vehicle 1 enters the protection zone for vulnerable road users (hereinafter, referred to as the “protection zone”). For example, the speed control module 110 can receive first data regarding whether the vehicle 1 enters the protection zone from the navigation device 21 of the vehicle 1 via the internal network of the vehicle 1. Based on this data, the speed control module 110 can determine whether a value of the first data indicates that the vehicle 1 enters the protection zone.

In some implementations, the navigation device 21 can assign a value indicating that the vehicle 1 enters the protection zone to the first data based on information regarding the protection zone specified on a map of the navigation device 21 and information regarding a current location of the vehicle 1 that can be recognized by a global positioning system (GPS) or the like. The speed control module 110, which receives the first data, can determine whether the vehicle 1 enters the protection zone based on the information included in the first data.

In some implementations, the navigation device 21 can assign coordinate values indicating the protection zone to the first data and then transmit these values to the speed control module 110. In this case, the speed control module 110 can acquire the current location of the vehicle 1 through another path, and determine whether the vehicle 1 enters the protection zone based on the information included in the first data and the current location of the vehicle 1.

In some implementations, the speed control module 110 can receive second data regarding the speed limit within the protection zone from the navigation device 21 of the vehicle 1 through the internal network of the vehicle 1. For example, the navigation device 21 can assign a value indicating the speed limit set for the protection zone specified in the first data to the second data and transmit this value to the speed control module 110.

The speed control module 110 can receive third data regarding a current speed of the vehicle 1 and fourth data regarding an accelerator pedal position of the vehicle 1 via the internal network of the vehicle 1 if the value of the first data is determined to indicate that the vehicle 1 enters the protection zone. In some implementations, the current speed of the vehicle 1 can receive these data from an engine control unit (ECU), a vehicle speed sensor (VSS), or the vehicle integration controller 20 implemented to include or be linked to their functions.

In some implementations, the accelerator pedal position of the vehicle 1 can be received from an accelerator pedal position sensor (APS) or the vehicle integration controller 20 implemented to include or be linked to its function.

The speed control module 110 can compare the current speed provided from the third data with the speed limit provided from the second data. The speed control module 110 can transmit the command to the vehicle integration controller 20 to decelerate the current speed if the current speed exceeds the speed limit. For example, the speed control module 110 can transmit the command to the vehicle integration controller 20 to decelerate the current speed to 30 km/h or less if the speed limit within the protection zone is 30 km/h and the current speed at which the vehicle 1 enters the protection zone is 40 km/h. Accordingly, the speed of the vehicle 1 can be reduced as soon as the vehicle 1 enters the protection zone for vulnerable road users, thereby reducing accident occurrences and preventing regulation violations.

In some implementations, the speed control module 110 can transmit a command, which is generated based on a predefined data format and instructing the vehicle to decelerate, to a vehicle deceleration and acceleration-related controller via CAN communication, if the current speed exceeds the speed limit. Here, the vehicle deceleration and acceleration-related controller can include an electronic stability control (ESC), a central drive control unit (CDCU), or the like. The speed control module 110 may or may not transmit the command to the vehicle integration controller 20 based on whether an accelerator pedal is pressed if the current speed is at or below the speed limit. The speed control module 110 can detect whether the accelerator pedal is pressed based on the accelerator pedal position provided from the fourth data if the current speed is at or below the speed limit. The speed control module 110 can observe the current speed provided from the third data if the accelerator pedal is determined to be pressed. The speed control module 110 can transmit the command to the vehicle integration controller 20 to override vehicle acceleration by accelerator pedal control when the current speed begins to exceed the speed limit provided from the second data.

Accordingly, the accident occurrences and the regulation violations can be reduced by preventing the vehicle 1 from accelerating beyond the speed limit within the protection zone for vulnerable road users.

In some implementations, the speed control module 110 can transmit a command, generated based on the predefined data format and configured to instruct to override the accelerator pedal control, to a vehicle engine-related controller via the CAN communication, if the current speed is at or below the speed limit. Here, the engine-related controller can include an engine management system (EMS), a vehicle control unit (VCU), or the like.

In some implementations, the vehicle deceleration can be accomplished in several ways. The vehicle 1 can include the memory or a storage device, which is accessible by the computing device and in which a value for setting a deceleration mode for the vehicle deceleration can be recorded, if the device 10 for driving assistance is implemented as the computing device. The speed control module 110 can receive the value for setting the deceleration mode from the memory or the storage device.

The speed control module 110 can transmit the command to the vehicle integration controller 20 to decelerate the current speed to first acceleration after a first time elapses after the vehicle 1 enters the protection zone if the value for setting the deceleration mode indicates a first deceleration mode. For example, the speed control module 110 can transmit the command to the vehicle integration controller 20 to perform the deceleration at an acceleration of “a” two seconds after the vehicle 1 enters the protection zone. The first deceleration mode can be used, for example, in cases where safety requirements are high in the protection zone, or where safety needs to be ensured urgently.

In some implementations, the speed control module 110 can transmit the command to the vehicle deceleration and acceleration-related controller, the command being generated to include a value specifying a time at which the deceleration begins and a value specifying the acceleration at which the deceleration is generated, and instructing the vehicle to decelerate from the current speed to a specified acceleration after a specified time elapses after the vehicle 1 enters the protection zone. Here, the vehicle deceleration and acceleration-related controller can include the electronic stability control (ESC), the central drive control unit (CDCU), or the like. Here, the value specifying a time at which the deceleration begins and the value specifying the acceleration at which the deceleration is generated can be acquired using a device in the vehicle that is capable of interacting with a user through a user interface, such as a vehicle navigation device or the storage device in the vehicle, or can be acquired using at least one of a server, a user terminal, or another vehicle, to which the vehicle can access through the network.

In some implementations, the speed control module 110 can transmit the command to the vehicle integration controller 20 to decelerate the current speed to second acceleration that is different from the first acceleration (e.g., second acceleration lower than the first acceleration) after the first time elapses after the vehicle 1 enters the protection zone if the value for setting the deceleration mode indicates a second deceleration mode that is different from the first deceleration mode. For example, the speed control module 110 can transmit the command to the vehicle integration controller 20 to perform the deceleration at an acceleration of “b” lower than “a” two seconds after the vehicle 1 enters the protection zone. The second deceleration mode can be used, for example, in cases where the safety requirements in the protection zone are at a normal level, or where the safety needs to be ensured within a normal time frame.

In some implementations, the speed control module 110 can transmit the command to the vehicle integration controller 20 to decelerate the current speed to the first acceleration or the second acceleration after a second time that is different from the first time (for example, the second time longer than the first time) elapses after the vehicle 1 enters the protection zone if the value for setting the deceleration mode indicates a third deceleration mode that is different from the first deceleration mode. For example, the speed control module 110 can transmit the command to the vehicle integration controller 20 to perform the deceleration at the specified acceleration three seconds after the vehicle 1 enters the protection zone. The third deceleration mode can be used, for example, to flexibly adjust a speed limit activation time.

The following vehicle collision avoidance module 120 can detect a situation where a collision with a following vehicle is likely to occur due to the speed limit or the acceleration limit, and deactivate the speed limit and the acceleration limit in the corresponding situation. For example, the following vehicle collision avoidance module 120 can receive fifth data regarding a current speed of the following vehicle via the internal network of the vehicle 1. Here, the current speed of the following vehicle can be acquired by the vehicle 1 through vehicle-to-vehicle (V2V) communication, vehicle-to-infrastructure (V2I) communication, or vehicle-to-everything (V2X) communication that integrates these communications.

In some implementations, the following vehicle collision avoidance module 120 can calculate the deceleration rate of the vehicle 1 based on the current speed provided from the third data, and calculate the deceleration rate of the following vehicle based on the current speed of the following vehicle that is provided from the fifth data. The following vehicle collision avoidance module 120 can compare the deceleration rate of the vehicle 1 calculated with the deceleration rate of the following vehicle, in this way. The following vehicle collision avoidance module 120 can detect the situation where the collision with the following vehicle is likely to occur due to the speed limit or the acceleration limit if the deceleration rate of the following vehicle is greater than the deceleration rate of the vehicle 1. Therefore, the following vehicle collision avoidance module 120 can transmit the command to the vehicle integration controller 20 to prevent a current speed limit control from being performed.

In some implementations, the following vehicle collision avoidance module 120 can detect the situation where the collision with the following vehicle is likely to occur due to the speed limit or the acceleration limit if the current speed of the following vehicle that is provided from the fifth data is greater than a predetermined reference speed. Therefore, the following vehicle collision avoidance module 120 can transmit the command to the vehicle integration controller 20 to prevent the current speed limit control from being performed.

In some Implementations, the following vehicle collision avoidance module 120 can detect the situation where the collision with the following vehicle is likely to occur due to the speed limit or the acceleration limit if the current speed of the following vehicle that is provided from the fifth data is greater than the current speed of the vehicle 1 that is provided from the third data. Therefore, the following vehicle collision avoidance module 120 can transmit the command to the vehicle integration controller 20 to prevent the current speed limit control from being performed.

As described above, in the situation where the collision with the following vehicle is likely to occur due to the speed limit or the acceleration limit, the speed limit or acceleration limit of the vehicle 1 can be temporarily suspended even if the vehicle is within the protection zone. The speed limit and the acceleration limit can then be activated again after the corresponding situation is resolved.

The speed recording module 130 can transmit the current speed of the vehicle 1 that is provided from the third data to the remote server 30 through the communication interface implemented in the vehicle 1 if the vehicle 1 is determined to enter the protection zone based on the information included in the first data. For example, the speed recording module 130 can transmit the current speed of the vehicle 1 that is provided from the third data to the remote server 30 at a preset intervals or in real time from a time point at which the vehicle 1 enters the protection zone to a time point at which the protection zone ends or to a time point at which a predetermined time elapses after the protection zone ends. A current speed record within the protection zone that is stored on the remote server 30 may be used as evidence if necessary, for example in an event of an accident. Thus, the evidence may be easily ensured by automatically ensuring the speed of vehicle 1 while driving within the protection zone.

The video recording module 140 can transmit the command to the black box 22 mounted on the vehicle 1 via the internal network of the vehicle 1 to instruct the black box 22 to start video recording if the vehicle 1 is determined to enter the protection zone based on the information included in the first data. For example, the video recording module 140 can perform the recording by using the black box 22 from the time point at which the vehicle 1 enters the protection zone to the time point at which the protection zone ends or to the time point at which the predetermined time elapses after the protection zone ends. The recorded records may be used as the evidence if necessary, for example, in the event of an accident. Thus, the evidence may be easily ensured by automatically ensuring a black box video while the vehicle 1 drives within the protection zone.

In some implementations, the user (e.g., driver) may be allowed to select whether to activate or deactivate the speed limit or acceleration limit of the vehicle 1. For example, the device 10 for driving assistance can display the user interface indicating a question about deactivating a function related to the driving assistance on a display device included in the vehicle 1. The device 10 for driving assistance can transmit the command to the vehicle integration controller 20 to prevent the current speed limit control from being performed if the user requests the deactivation of the function through the user interface.

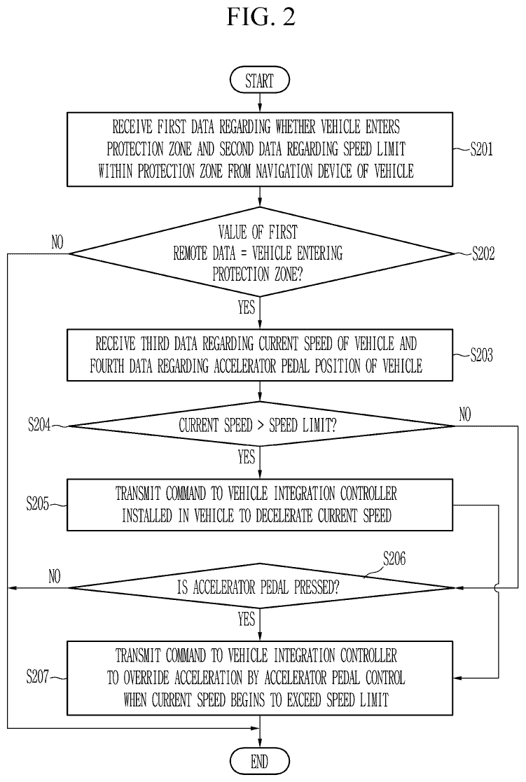

FIG. 2 is a diagram illustrating an example of a method for driving assistance.

Referring to FIG. 2, the method for driving assistance can include receiving the first data regarding whether the vehicle enters the protection zone and the second data regarding the speed limit within the protection zone from the navigation device of the vehicle (S201), and determining whether a value of first remote data indicates that the vehicle enters the protection zone (S202).

The method can include receiving the third data regarding the current speed of the vehicle and the fourth data regarding the accelerator pedal position of the vehicle (S203), and comparing the current speed with the speed limit (S204) if the value of the first remote data is determined to indicate that the vehicle enters the protection zone (“YES”in S202).

The method can include transmitting the command to the vehicle integration controller installed in the vehicle to decelerate the current speed (S205) if the current speed exceeds the speed limit (“YES”in S204).

The method can include detecting whether the accelerator pedal is pressed based on the accelerator pedal position (S206) if the current speed is less than or equal to the speed limit (“NO” in S204). The method can include transmitting the command to the vehicle integration controller to override the acceleration by the accelerator pedal control when the current speed provided from the third data begins to exceed the speed limit (S207) if the accelerator pedal is pressed (“YES”in S206).

For more detailed information on the method, descriptions of other implementations included in this specification may be referred to, and its redundant description is thus omitted.

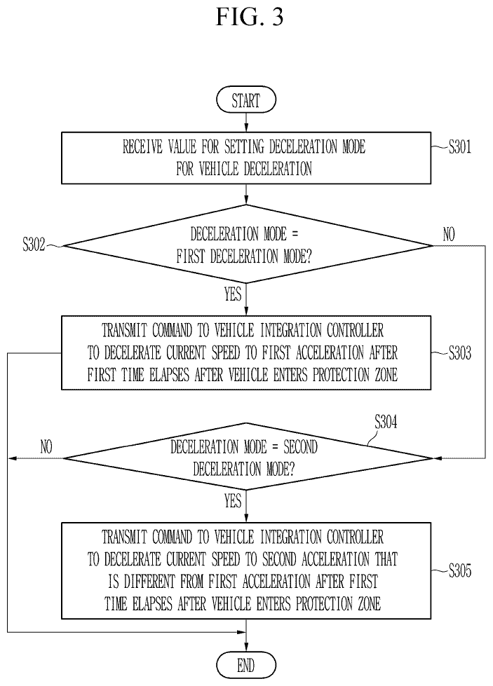

FIG. 3 is a diagram illustrating an example of a method for driving assistance.

Referring to FIG. 3, the method for driving assistance can include receiving the value for setting the deceleration mode for the vehicle deceleration (S301), and determining whether the deceleration mode indicates the first deceleration mode (S302).

The method can include transmitting the command to the vehicle integration controller to decelerate the current speed to the first acceleration after the first time elapses after the vehicle enters the protection zone (S303) if the deceleration mode is determined to indicate the first deceleration mode (“YES” in S302).

The method can include transmitting the command to the vehicle integration controller to decelerate the current speed to the second acceleration that is different from the first acceleration after the first time elapses after the vehicle enters the protection zone (S305) if the deceleration mode is determined to indicate the second deceleration mode (“YES” in S304).

For more detailed information on the method, descriptions of other implementations included in this specification may be referred to, and its redundant description is thus omitted.

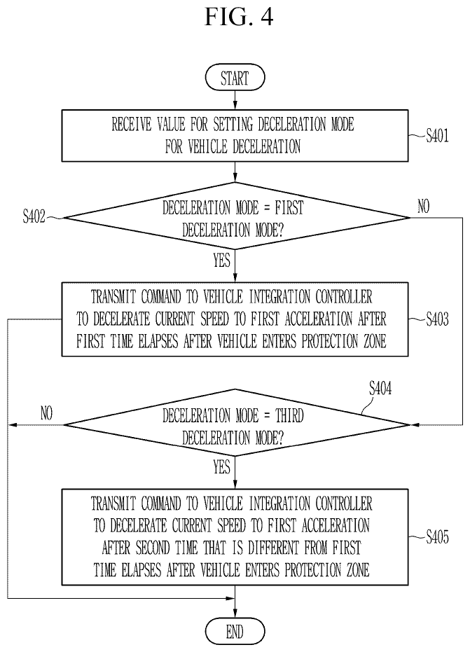

FIG. 4 is a diagram illustrating an example of a method for driving assistance.

Referring to FIG. 4, the method for driving assistance can include receiving the value for setting the deceleration mode for the vehicle deceleration (S401), and determining whether the deceleration mode indicates the first deceleration mode (S402).

The method can include transmitting the command to the vehicle integration controller to decelerate the current speed to the first acceleration after the first time elapses after the vehicle enters the protection zone (S403) if the deceleration mode is determined to indicate the first deceleration mode (“YES” in S402).

The method can include transmitting the command to the vehicle integration controller to decelerate the current speed to the first acceleration after the second time that is different from the first time elapses after the vehicle enters the protection zone (S405) if the deceleration mode is determined to indicate the third deceleration mode (“YES”in S404).

For more detailed information on the method, descriptions of other implementations included in this specification may be referred to, and its redundant description is thus omitted.

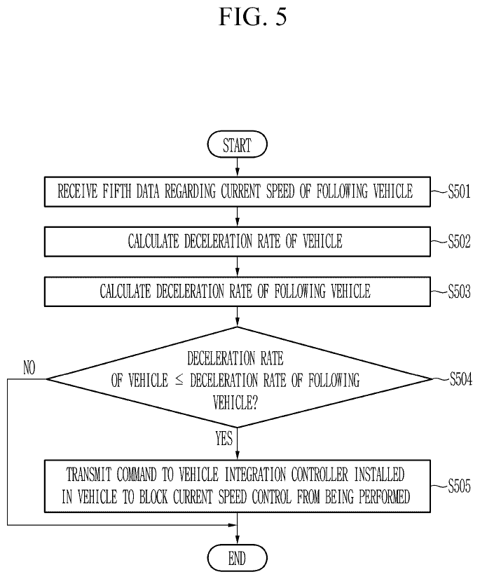

FIG. 5 is a diagram illustrating an example of a method for driving assistance.

Referring to FIG. 5, the method for driving assistance can include receiving the fifth data regarding the current speed of the following vehicle (S501), calculating the deceleration rate of the vehicle (S502), calculating the deceleration rate of the following vehicle (S503), and determining whether the deceleration rate of the following vehicle is greater than the deceleration acceleration of the vehicle (S504).

The method can include transmitting the command to the vehicle integration controller installed in the vehicle to block the current speed control from being performed (S505) if the deceleration rate of the following vehicle is determined to be greater than the deceleration rate of the vehicle.

For more detailed information on the method, descriptions of other implementations included in this specification may be referred to, and its redundant description is thus omitted.

FIG. 6 is a diagram illustrating an example of a computing device.

Referring to FIG. 6, the method and device for driving assistance can be implemented using the computing device 50. The computing device 50 can be implemented as any of various types of electronic devices, servers, or similar devices, and its function can be implemented through a combination of software and hardware.

The computing device 50 can include at least one of the processor 510, the memory 530, a user interface input device 540, a user interface output device 550, and a storage device 560, performing their communications with one another using a bus 520. The computing device 50 can also include a network interface 570 electrically connected to the network 40. The network interface 570 can transmit or receive a signal with another entity through the network 40.

The processor 510 can be implemented as any of various types of computing units, such as a micro controller unit (MCU), an application processor (AP), a central processing unit (CPU), a graphic processing unit (GPU), a neural processing unit (NPU), or a quantum processing unit (QPU). The processor 510 can also be a semiconductor device that executes an instruction stored in the memory 530 or the storage device 560, and can perform a core function of a system. A program code and data stored in the memory 530 or the storage device 560 can instruct the processor 510 to perform a specific task, thereby enabling overall operations of the system. In this way, the processor 510 can implement the various functions and methods described above with reference to FIGS. 1 to 5.

The memory 530 and the storage device 560 can include various types of volatile or non-volatile storage media for storing and accessing data in the system. For example, the memory 530 can include a read only memory (ROM) 531 and a random access memory (RAM) 532. In some implementations, the memory 530 can be embedded in the processor 510, in which case data transmission between the memory 530 and the processor 510 may be performed at a very fast speed. In some implementations, the memory 530 can be disposed outside the processor 510, in which case the memory 530 can be connected to the processor 510 through various data buses or interfaces. This connection can be made by various means already known, for example, through a peripheral component interconnect express (PCIe) interface for the high-speed data transmission or through a memory controller.

In some implementations, at least some components or functions of the method and device for driving assistance can be implemented as a program or software executed by the computing device 50, and the program or software can be stored on the computer-readable recording medium or storage medium. In detail, the computer-readable recording medium or storage medium can have a program recorded for executing steps included in the implementation of the method and the device for driving assistance that is recoded on a computer including the processor 510 executing the program or the instruction, stored in the memory 530 or the storage device 560.

In some implementations, at least some components or functions of the method and the device for driving assistance can be implemented using the hardware or circuitry of the computing device 50, or implemented using a separate hardware or circuitry that can be electrically connected to the computing device 50.

According to implementations of features described in the present disclosure, the vehicle speed and acceleration may be automatically limited as soon as the vehicle enters the protection zone for vulnerable road users, and the speed recording and black box video recording may be enforced within the protection zone for vulnerable road users, thereby reducing the accident occurrences, preventing the regulation violations, and allowing the evidence to be easily secured in the event of an accident. In addition, the flexibility may be ensured simultaneously by deactivating the speed and acceleration control functions if there is a concern that the vehicle speed and acceleration control may rather compromise the safety.

What is claimed is:

1. A method for driving assistance performed by a computing device implemented in a vehicle and implemented using a processor and a communication interface, the method comprising:
receiving, from a navigation device, first data regarding whether the vehicle enters a specified zone and second data regarding a speed limit within the specified zone;
determining whether a value of the first data indicates that the vehicle enters the specified zone;
receiving, based on a determination that the value of the first data indicates that the vehicle enters the specified zone, third data regarding a current speed of the vehicle and fourth data regarding an accelerator pedal position of the vehicle;
comparing the current speed from the third data with the speed limit from the second data;
based on the current speed exceeding the speed limit, transmitting, to a vehicle integration controller installed in the vehicle, a command to thereby cause the vehicle to decelerate the current speed;
based on the current speed being at or below the speed limit, detecting, whether an accelerator pedal is pressed according to the accelerator pedal position provided from the fourth data; and
transmitting, based on the current speed exceeding the speed limit and the accelerator pedal being pressed, a command to the vehicle integration controller to override vehicle acceleration by accelerator pedal control.

2. The method of claim 1, further comprising:
receiving, from a memory or a storage device, a value for setting a deceleration mode for vehicle deceleration, and
wherein transmitting the command to the vehicle integration controller to decelerate the current speed comprises, transmitting, based on the value for setting the deceleration mode indicating a first deceleration mode, the command to the vehicle integration controller to decelerate the current speed to first acceleration once a first time elapses after the vehicle enters the specified zone.

3. The method of claim 2, wherein transmitting the command to the vehicle integration controller to decelerate the current speed comprises:
transmitting, based on the value for setting the deceleration mode indicating a second deceleration mode that is different from the first deceleration mode, the command to the vehicle integration controller to decelerate the current speed to second acceleration that is different from the first acceleration once the first time elapses after the vehicle enters the specified zone.

4. The method of claim 3, wherein transmitting the command to the vehicle integration controller to decelerate the current speed comprises:
transmitting, based on the value for setting the deceleration mode indicating a third deceleration mode that is different from the first deceleration mode, the command to the vehicle integration controller to decelerate the current speed to the first acceleration or the second acceleration once a second time that is different from the first time elapses after the vehicle enters the specified zone.

5. The method of claim 1, further comprising:
receiving fifth data regarding a current speed of a following vehicle;
calculating a deceleration rate of the vehicle based on the third data;
calculating a deceleration rate of the following vehicle based on the fifth data;
comparing the deceleration rate of the vehicle with the deceleration rate of the following vehicle; and
transmitting, based on the deceleration rate of the following vehicle being greater than the deceleration rate of the vehicle, a command to the vehicle integration controller to block current speed control from being performed.

6. The method of claim 1, further comprising:
receiving fifth data regarding a current speed of a following vehicle; and
transmitting, based on the current speed of the following vehicle being greater than a predetermined reference speed, a command to the vehicle integration controller to block current speed control from being performed.

7. The method of claim 1, further comprising:
receiving fifth data regarding a current speed of a following vehicle; and
transmitting, based on the current speed of the following vehicle being greater than the current speed of the vehicle, a command to the vehicle integration controller to block current speed control from being performed.

8. The method of claim 1, further comprising:
displaying, on a display disposed at the vehicle, a user interface indicating deactivation of a function related to the driving assistance; and
transmitting, based on a request for the deactivation being received through the user interface, a command to the vehicle integration controller to block current speed control from being performed.

9. The method of claim 1, further comprising:
transmitting, based on the value of the first data indicating that the vehicle enters the specified zone, the current speed to a remote server through a communication interface.

10. The method of claim 1, further comprising
transmitting, based on the value of the first data indicating that the vehicle enters the specified zone, a command to a black box disposed at the vehicle to instruct the black box to start video recording.

11. A device for driving assistance comprising:
at least one memory storing instructions; and
at least one processor configured to execute the instructions to perform operations comprising:
receiving, from a navigation device, first data regarding whether a vehicle enters a specified zone and second data regarding a speed limit within the specified zone;
determining whether a value of the first data indicates that the vehicle enters the specified zone;
receiving, based on a determination that the value of the first data indicates that the vehicle enters the specified zone, third data regarding a current speed of the vehicle and fourth data regarding an accelerator pedal position of the vehicle;
comparing the current speed from the third data with the speed limit from the second data;
based on the current speed exceeding the speed limit, transmitting, to a vehicle integration controller installed in the vehicle, a command to thereby cause the vehicle to decelerate the current speed;
based on the current speed being at or below the speed limit, detecting, whether an accelerator pedal is pressed according to the accelerator pedal position provided from the fourth data; and
transmitting, based on the current speed exceeding the speed limit and the accelerator pedal being pressed, a command to the vehicle integration controller to override vehicle acceleration by accelerator pedal control.

12. The device of claim 11, wherein the operations further comprise:
receiving, from a memory or a storage device, a value for setting a deceleration mode for vehicle deceleration, and
wherein transmitting the command to the vehicle integration controller to decelerate the current speed comprises, transmitting, based on the value for setting the deceleration mode indicating a first deceleration mode, the command to the vehicle integration controller to decelerate the current speed to first acceleration once a first time elapses after the vehicle enters the specified zone.

13. The device of claim 12, wherein transmitting the command to the vehicle integration controller to decelerate the current speed comprises:
transmitting, based on the value for setting the deceleration mode indicating a second deceleration mode that is different from the first deceleration mode, the command to the vehicle integration controller to decelerate the current speed to second acceleration that is different from the first acceleration once the first time elapses after the vehicle enters the specified zone.

14. The device of claim 13, wherein transmitting the command to the vehicle integration controller to decelerate the current speed comprises:
transmitting, based on the value for setting the deceleration mode indicating a third deceleration mode that is different from the first deceleration mode, the command to the vehicle integration controller to decelerate the current speed to the first acceleration or the second acceleration once a second time that is different from the first time elapses after the vehicle enters the specified zone.

15. The device of claim 11, wherein the operations further comprise:
receiving fifth data regarding a current speed of a following vehicle;
calculating a deceleration rate of the vehicle based on the third data;
calculating a deceleration rate of the following vehicle based on the fifth data;
comparing the deceleration rate of the vehicle with the deceleration rate of the following vehicle; and
transmitting, based on the deceleration rate of the following vehicle being greater than the deceleration rate of the vehicle, a command to the vehicle integration controller to block current speed control from being performed.

16. The device of claim 11, wherein the operations further comprise:
receiving fifth data regarding a current speed of a following vehicle; and
transmitting, based on the current speed of the following vehicle being greater than a predetermined reference speed, a command to the vehicle integration controller to block current speed control from being performed.

17. The device of claim 11, wherein the operations further comprise:
receiving fifth data regarding a current speed of a following vehicle; and
transmitting, based on the current speed of the following vehicle being greater than the current speed of the vehicle, a command to the vehicle integration controller to block current speed control from being performed.

18. The device of claim 11, wherein the operations further comprise:
displaying, on a display disposed at the vehicle, a user interface indicating deactivation of a function related to the driving assistance; and
transmitting, based on a request for the deactivation being received through the user interface, a command to the vehicle integration controller to block current speed control from being performed.

19. The device of claim 11, wherein the operations further comprise:
transmitting, based on the value of the first data indicating that the vehicle enters the specified zone, the current speed to a remote server through a communication interface.

20. A non-trasnitory computer-readable recording medium storing an instruction causing a computing device implemented in a vehicle to execute operations comprising:
receiving, from a navigation device, first data regarding whether the vehicle enters a specified zone and second data regarding a speed limit within the specified zone;
determining whether a value of the first data indicates that the vehicle enters the specified zone;
receiving, based on a determination that the value of the first data indicates that the vehicle enters the specified zone, third data regarding a current speed of the vehicle and fourth data regarding an accelerator pedal position of the vehicle;
comparing the current speed from the third data with the speed limit from the second data;
based on the current speed exceeding the speed limit, transmitting, to a vehicle integration controller installed in the vehicle, a command to thereby cause the vehicle to decelerate the current speed;
based on the current speed being at or below the speed limit, detecting, whether an accelerator pedal is pressed according to the accelerator pedal position provided from the fourth data; and
transmitting, based on the current speed exceeding the speed limit and the accelerator pedal being pressed, a command to the vehicle integration controller to override vehicle acceleration by accelerator pedal control.
